(19) United States
(12) Patent Application Publication
(10) Pub. No.: US 2005/0046324 A1
(43) Pub. Date: Mar. 3, 2005

(54) Lamp base for a high-pressure discharge lamp and high-pressure discharge lamp

(75) Inventors: Gerhard Behr, Altheim (DE); Matthias Burkhardt, Hohenbrunn (DE); Peter Helbig, Sontheim (DE); Arnulf Rupp, Taufkirchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 10/919,415

(22) Filed: Aug. 17, 2004

(30) Foreign Application Priority Data
Aug. 26, 2003 (DE) 103 39 588.1

(51) Int. Cl. H01J 5/48; H01J 5/50

(52) U.S. Cl. 313/318.01; 313/318.12

(57) ABSTRACT

The invention relates to a lamp base and to a high-pressure discharge lamp having a starting transformer arranged in the lamp base. According to the invention, an electrical contact element, which connects the starting voltage output of the starting transformer to the inner power supply line which protrudes from the discharge vessel, is in the form of a module having a plastic injection-molded part of the lamp base.

### I. TECHNICAL FIELD

The invention relates to a lamp base for a high-pressure discharge lamp having a holder for a transformer, an electrical contact element being arranged in the lamp base and serving the purpose of connecting a voltage output of the transformer to a power supply line which is passed out of the discharge vessel of the high-pressure discharge lamp.

### II. BACKGROUND ART

Such a lamp base and such a high-pressure discharge lamp are disclosed, for example, in laid-open patent specification WO 00/59269. This specification describes a lamp base having a starting apparatus integrated in it which has a starting transformer, whose starting voltage output is connected by means of an electrical contact element to a power supply line which is passed out of the discharge vessel of the high-pressure discharge lamp. The electrical contact element is in the form of a stamped, bent part, whose ends are welded to the starting voltage output and to the power supply line.

### III. DISCLOSURE OF THE INVENTION

It is the object of the invention to provide a lamp base for a high-pressure discharge lamp and a corresponding high-pressure discharge lamp having improved insulation for the abovementioned electrical contact element and having a simpler design.

This object is achieved according to the invention by a lamp base for a high-pressure discharge lamp having a holder for a transformer, an electrical contact element being arranged in the lamp base and serving the purpose of connecting a voltage output) of the transformer to a power supply line which is passed out of the discharge vessel of the high-pressure discharge lamp, wherein said electrical contact element is in the form of a module having a plastic injection-molded part of the lamp base. Particularly advantageous embodiments of the invention are described in the dependent patent claims.

The lamp base according to the invention has a holder for a transformer and is equipped with an electrical contact element which serves the purpose of connecting a voltage output of the transformer to a power supply line which is passed out of the discharge vessel of the high-pressure discharge lamp, and which, according to the invention, is in the form of a module having a plastic injection-molded part of the lamp base. As a result, the electrical contact element is almost completely embedded in an interlocking manner in the material of the plastic injection-molded part, the material of the plastic injection-molded part ensuring that the electrical contact element has favorable electrical insulation. In addition, precise, spatial arrangement and alignment make it possible for the electrical contact element to be embedded in an interlocking manner in the plastic injection-molded part. The lamp base according to the invention therefore also make it easier for contact to be made between the starting voltage transformer and the lamp power supply line.

In order to ensure a design of the lamp base which is as compact as possible and good electrical insulation of the starting transformer, the plastic injection-molded part of the lamp base according to the invention advantageously has at least two chambers, a first chamber being in the form of a holder for a transformer, which preferably acts as a starting transformer for the high-pressure discharge lamp, and a first end of the electrical contact element extending into the first chamber in order to make it possible to make an electrical connection to the voltage output of the transformer, whereas a second end of the electrical contact element is advantageously accessible from the second chamber of the plastic injection-molded part, in order for it to be available there for an electrical connection to be made to a power supply line of the high-pressure discharge lamp. The ends of the electrical contact element are preferably provided with flat contact faces in order to ensure good electrical contact and a good welded connection to the voltage output of the transformer or to the power supply line. The second end of the electrical contact element preferably has a hole for the power supply line. The power supply line is threaded through this hole and welded at the rear to the second end of the contact element in order to produce a reliable connection between the electrical contact element and the power supply line.

The high-pressure discharge lamp according to the invention has a lamp base having a starting transformer arranged in it for the purpose of generating the starting voltage for the high-pressure discharge lamp, an electrical contact element being arranged in the lamp base and being connected to the starting voltage output of the starting transformer and to a power supply line which is passed out of the discharge vessel of the high-pressure discharge lamp, and, according to the invention, being in the form of a module having a plastic injection-molded part of the lamp base. As has already been explained above, as a result, the electrical contact element is almost completely embedded in an interlocking manner in the material of the plastic injection-molded part, with the result that the material of the plastic injection-molded part ensures that the electrical contact element has excellent electrical insulation. In addition, precise spatial arrangement and alignment are made possible by the electrical contact element being embedded in an interlocking manner in the plastic injection-molded part. The lamp base according to the invention therefore also makes it easier for contact to be made between the starting voltage transformer and the lamp power supply line.

The plastic injection-molded part preferably has at least two chambers, a first end of the electrical contact element extending into the first chamber, and a second end of the electrical contact element being accessible from the second chamber. This makes possible a separate spatial arrangement of the high voltage-carrying starting transformer. The starting transformer is preferably arranged in the first chamber of the plastic injection-molded part, and the first end of the electrical contact element is connected to the starting voltage output of the transformer, whereas further electronic components of the starting apparatus for the high-pressure discharge lamp can be accommodated in the second chamber, said components having lower requirements in terms of voltage insulation than the starting transformer. The second end of the electrical contact element is accessible from the second chamber of the plastic injection-molded part and is preferably connected there to the end of a power supply line which is passed out of the discharge vessel of the high-pressure discharge lamp. The connection point between the second end of the electrical contact element and the end of the power supply line is advantageously provided with electrical insulation which is preferably in the form of an electrically insulating sealing compound in which the connection point is embedded. The interspace between the walls of the first chamber of the plastic injection-molded part and the starting transformer is preferably filled with an electrically insulating sealing compound in order to increase the ability of the lamp base to withstand high voltages.

### IV. BRIEF DESCRIPTION OF THE DRAWINGS

The invention is explained in more detail below with reference to a preferred exemplary embodiment. In the drawings:

FIG. 1 shows a side view of a high-pressure discharge lamp according to the preferred exemplary embodiment of the invention,

FIG. 2 shows a plan view of the base outer part of the lamp base of the high-pressure discharge lamp depicted in FIG. 1,

FIG. 3 shows a partially sectioned illustration of a side view of the base outer part depicted in FIG. 2,

FIG. 4 shows a plan view of the electrical contact element for connecting the starting voltage transformer and the inner power supply line of the high-pressure discharge lamp,

FIG. 5 shows a side view of the module, which is fixed in the base inner part and comprises the discharge vessel and the outer bulb, of the high-pressure discharge lamp depicted in FIG. 1,

FIG. 6 shows a plan view of the starting transformer of the high-pressure discharge lamp depicted in FIG. 1, and

FIG. 7 shows a plan view of the mounting plate which is arranged in the lamp base of the high-pressure discharge lamp depicted in FIG. 1.

### V. BEST MODE FOR CARRYING OUT THE INVENTION

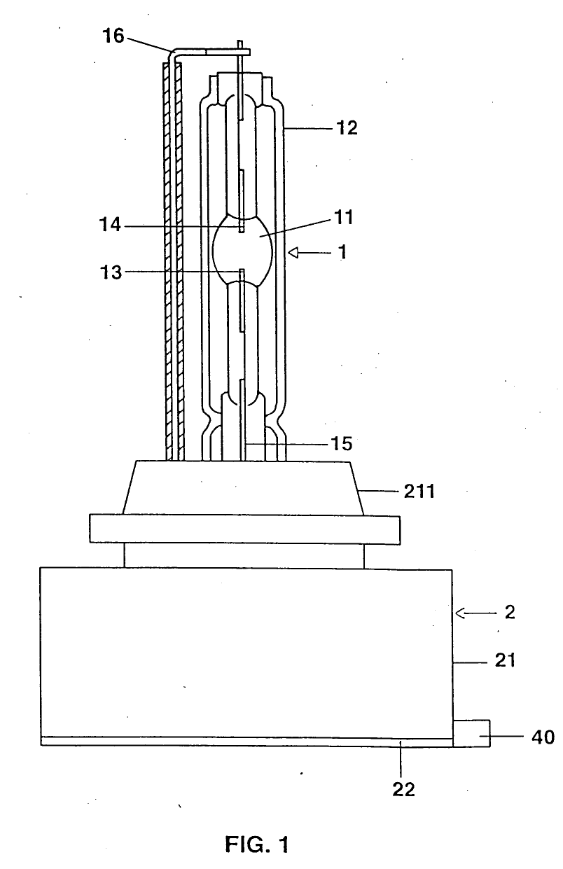

The preferred exemplary embodiment of the invention depicted in FIG. 1 is a high-pressure discharge lamp for a vehicle headlamp which has a base at one end. This high-pressure discharge lamp has a discharge vessel 11, which is made of silica glass, is surrounded by a vitreous outer bulb 12 and has electrodes 13, 14 arranged in it for the purpose of generating a gas discharge. The electrodes 13, 14 are each connected to a power supply line 15 and 16, respectively, which is passed out of the discharge vessel 11, and by means of which they are supplied with electrical power. The module 1, which comprises the discharge vessel 11 and the outer bulb 12, is fixed in the base inner part 23, depicted in FIG. 5, of the lamp base 2. The lamp base 2 essentially comprises the base inner part 23, the base outer part 21, the lid 22 and the connection socket 40. The base outer part 21 is provided with a holder 211 in which the base inner part 23 is arranged and fitted. The base inner part 23 and the holder 211 are provided with fastening means 231, 212 which are matched to one another for the purpose of fitting the base inner part 23 in the holder 211 of the base outer part 21. The base outer part 21 is in the form of a plastic injection-molded part and is made of polyetherimides, which is also known under the designation Ultem®2300.

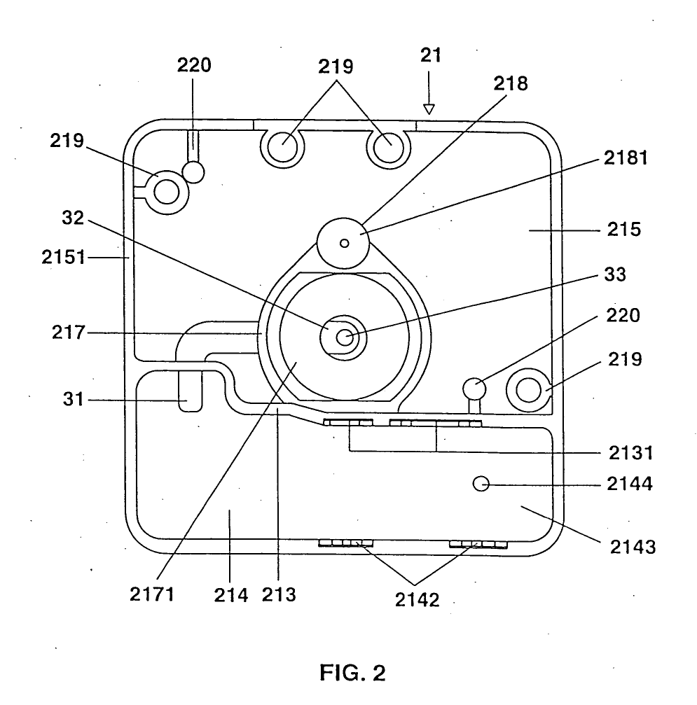

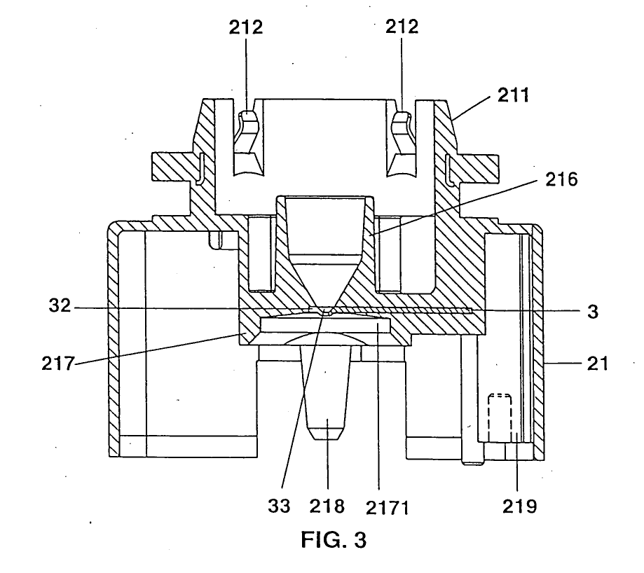

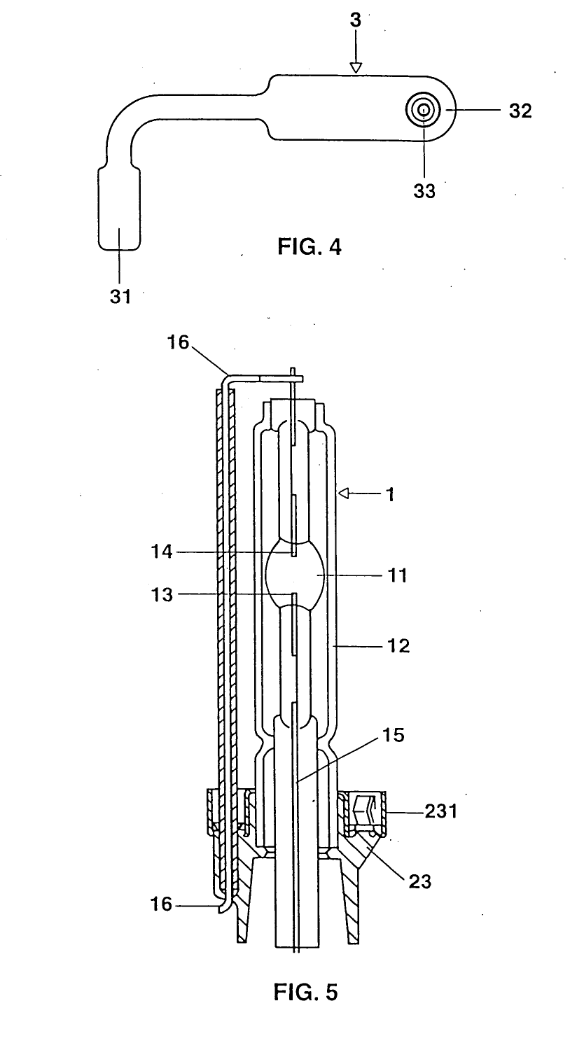

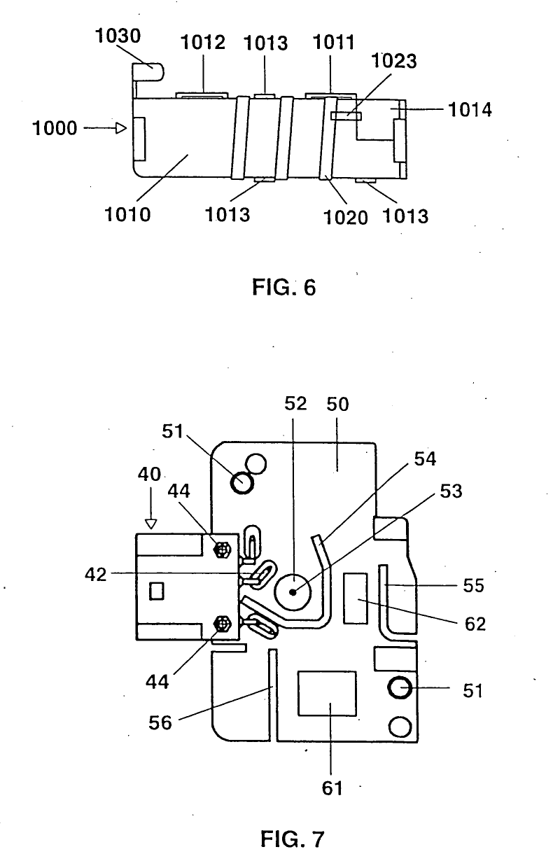

FIG. 2 shows a plan view of the side of the base outer part 21 which is remote from the lamp vessels 11, 12, before the lid 22 is fitted. The base outer part 21 has an essentially square cross section. The interior of the base outer part 21 is divided by a partition wall 213 into two chambers 214, 215 of different size. Arranged in the smaller, first chamber 214 is a rod-core transformer 1000 which acts as the starting transformer for the pulse starting apparatus of the high-pressure discharge lamp accommodated in the lamp base 2. The remaining components of the pulse starting apparatus, in particular the starting capacitor 61 and the spark gap 62, are arranged in the larger, second chamber 215. The electrical contact element 3 depicted in FIG. 4 is embedded in the base outer part 21. It is made of high-grade steel and forms a module with the base outer part 21. Its ends 31, 32 have flat contact faces. The electrical contact element 3 has already been injected into the plastic injection-molded part 21 when the latter was produced, with the result that it is almost completely surrounded by the material of the base outer part 21, and only the ends 31, 32 of the contact element 3 are accessible for the purpose of making contact. The first end 31 of the electrical contact element 3 extends into the first chamber 214 and, after the rod-core transformer has been fitted, is welded to the high voltage-carrying starting voltage output of the rod-core transformer. The second end 32 of the electrical contact element 3, which is provided with a through-hole 33 for the inner power supply line 15, extends into the second chamber 215. The inner power supply line 15, which is arranged on the longitudinal axis of the high-pressure discharge lamp and protrudes from the discharge vessel 11, runs in the conically tapered tube 216 of the base outer part 21 and is threaded through the hole 33 in the second end 32 of the electrical contact element 3, which extends directly into the conically tapered end of the tube 216. The conical or funnel-shaped tapering of the tube 216 makes it easier to thread the power supply line 15 through the hole 33 in the contact element 3. The end of the power supply line 15 which is threaded through the hole 33 is welded to the second end 32 of the contact element 3 on the side of the electrical contact element 3 which is remote from the tube 216 (not shown). Provided in the base outer part 21, on the side of the contact element 3 which is remote from the tube 216, is a trough 2171 which is delimited by a hollow-cylindrical web 217. The second end 32 of the contact element 3 forms part of the base of the trough. Once the inner power supply line 15 has been welded to the second end 32 of the contact element 3, the trough 2171 is filled with an electrically insulating sealing compound, with the result that the welded joint between the two lamp components 15, 32 is embedded in the sealing compound. The end, which is fed back into the base 2, of the outer power supply line 16, which protrudes from the end of the discharge vessel 11 which is remote from the base, extends into the hollow-cylindrical web 218 which is likewise integrally formed on the base outer part 21. Further hollow-cylindrical webs 219 serve the purpose of fixing the lid 22 and of fixing the connection socket 40 which forms the electrical connection with the high-pressure discharge lamp. The end of the web 218 is equipped with a bearing face 2181 for a mounting plate 50, whose form matches the cross section of the second chamber 215 so as to fit. The mounting plate 50, once it has been fitted, closes the chamber 215. The modules arranged on the mounting plate 50, such as the starting capacitor 61 and the spark gap 62 of the pulse starting apparatus, for example, project into the second chamber 215. Two or more guide rails 2142, 2131 for the rod-core transformer 1000 are arranged in the side walls 2151, 213 of the first chamber 214. The guide rails 2142, 2131 are matched to corresponding webs 1011, 1012, 1013 on the housing 1010 of the rod-core transformer 1000 such that they fit, with the result that the position of the rod-core transformer 1000 can thus be fixed in the first chamber 214. In addition, a nipple 2144, which, together with the first end 31 of the contact element 3, determines the mounting depth of the rod-core transformer 1000, is located in the base 2143 of the chamber 214. The starting voltage output 1030 of the rod-core transformer 1000 rests on the first end 31 of the contact element 3 and is welded to it, whereas the housing 1010 of the rod-core transformer 1000 rests on the nipple 2144. The interspace between the rod-core transformer 1000 and the side walls 2151, 213 of the first chamber 214 is filled with an electrically insulating sealing compound. The sealing compound passes through the ventilation openings 1014 into the interior of the transformer housing 1010, too. The primary winding 1020 of the rod-core transformer 1000 comprises a metal strip and is wound on the outside of the housing 1010. The lid 22 covers the mounting plate 50 and closes the two chambers 214, 215 of the base outer part 21.

FIG. 7 shows the mounting plate 50 which covers the second chamber 215 of the base outer part 21. The plug socket 40, which acts as an electrical connection for the high-pressure discharge lamp, and the starting capacitor 61, the spark gap 62 and other electronic modules of a starting apparatus for the high-pressure discharge lamp depicted in FIG. 1 are arranged on the mounting plate 50. The three contact pins 42 of the plug socket 40 are each connected, by means of conductor tracks (not depicted) arranged on the mounting plate 50, to the annular, metallic contact element 52 which is embedded in the mounting plate 50, to the starting capacitor 61, to the spark gap 62 or to other electronic modules. The annular contact element 52 comprises a metal sheet, for example made of copper, steel or a copper or steel alloy. The mounting plate 50 is placed on the base outer part 21 such that the modules 61, 62 of the starting apparatus which are mounted on the mounting plate 50 project into the second chamber 215 of the base outer part, and the pins 44 of the plug socket 40 engage in the hollow webs 219 of the base outer part 21 and the webs 220 engage in the perforations 51 in the mounting plate. The end of the outer power supply line 16 which protrudes from the hollow web 218 of the base outer part 21 is in this case passed through the annular opening 53 in the contact element 52 and is welded or soldered on the reverse of the mounting plate 50 to the contact element 52. Two or more perforations 54, 55, 56 are provided in the mounting plate for the purpose of electrically insulating the annular contact element 52 and other modules of the starting apparatus from the starting capacitor 61 and the spark gap 62.

1. A lamp base for a high-pressure discharge lamp having a holder for a transformer, an electrical contact element being arranged in the lamp base and serving the purpose of connecting a voltage output of the transformer to a power supply line which is passed out of the discharge vessel of the high-pressure discharge lamp, wherein said electrical contact element is in the form of a module having a plastic injection-molded part of said lamp base.

2. The lamp base as claimed in claim 1, wherein said plastic injection-molded part has at least two chambers, a first end of the electrical contact element extending into a first chamber of the plastic injection-molded part, which is in the form of a holder for the transformer, and a second end of the electrical contact element being accessible from the second chamber of the plastic injection-molded part (21).

3. The lamp base as claimed in claim 2, wherein the ends of the electrical contact element have flat contact faces.

4. The lamp base as claimed in claim 2, wherein the second end of the electrical contact element is provided with a hole.

5. A high-pressure discharge lamp having a lamp base and a starting transformer arranged in the lamp base for the purpose of generating the starting voltage for the high-pressure discharge lamp, an electrical contact element being arranged in the lamp base and being connected to said starting voltage output of the starting transformer and to a power supply line which is passed out of the discharge vessel of the high-pressure discharge lamp,
wherein said electrical contact element is in the form of a module having a plastic injection-molded part of the lamp base.

6. The high-pressure discharge lamp as claimed in claim 5, wherein the plastic injection-molded part has at least two chambers, a first end of the electrical contact element extending into the first chamber, and a second end of the electrical contact element being accessible from the second chamber.

7. The high-pressure discharge lamp as claimed in claim 6, wherein the starting transformer is arranged in the first chamber, and the first end of the electrical contact element is connected to the starting voltage output of the starting transformer.

8. The high-pressure discharge lamp as claimed in claim 6, wherein the second end of the electrical contact element is connected to the power supply line which is passed out of the discharge vessel.

9. The high-pressure discharge lamp as claimed in claim 8, wherein the second end of the electrical contact element is provided with a hole for the power supply line.

10. The high-pressure discharge lamp as claimed in claim 7, wherein the interspace between the walls of the first chamber and the starting transformer is filled with an electrically insulating sealing compound.

11. The high-pressure discharge lamp as claimed in claim 6, wherein the connection point of the second end of the electrical contact element with the power supply line is provided with electrical insulation.

12. The high-pressure discharge lamp as claimed in claim 11, wherein the electrical insulation is a sealing compound in which the connection point is embedded.
